(19) United States
(12) Patent Application Publication
(10) Pub. No.: US 2009/0000875 A1
(43) Pub. Date: Jan. 1, 2009

(54) Lubricating Oil Balance Equipment and One Shaft Equipped with the Same

(76) Inventors: Hongzhuan Zheng, Henan Province (CN); Linzhen Zhao, Henan Province (CN)

Correspondence Address: MERCHANT & GOULD PC, P.O. BOX 2903, MINNEAPOLIS, MN, 55402-0903, US

(21) Appl. No.: 10/586,031

(22) PCT Filed: Dec. 29, 2004
(86) PCT No.: PCT/CN2004/001565

§ 371 Date: Sep. 5, 2008

(30) Foreign Application Priority Data
Jan. 20, 2004 (CN) 200410002871.3

(51) Int. Cl. F16N 1/00; F16N 21/00

(52) U.S. Cl. 184/7.4; 464/7

(57) ABSTRACT

This invention relates to a lubricating oil balance equipment, which includes a main body forming a non-closed loop and a extending portion which extends from said main body along axis direction. This structure can make the lubricating oil entered the open end of said main body flow out from the extending portion. Lubricating oil in the lubricating oil balance equipment can be only when it reaches the highest level of the main body and flows through the extending portion, this structure can ensure the uniformity of oil in different parts, which is beneficial to lubricate bearings and the life of bearings.

### FIELD OF THE INVENTION

The present invention relates to a lubricating oil balance equipment.

### BACKGROUND OF THE INVENTION

In the agricultural and industrial fields, bearings are wildly used. The bearings need be guaranteed lubrication in using process. Lubricating oil passing by a lubricating oil channels formed in a shaft is used to actualize lubrication of the bearings generally. But in actual using, equal supplying the lubricating oil is not guaranteed frequently because of large quantity of the bearings. There are much lubricating oil in some bearings and little lubricating oil in the other bearings. Such as in the mill field, as shown in FIG. 1, a mill includes multiple shafts 10 and 20, and lubricating oil lubricates components such as bearings installed around the external circle surface of the shafts through lubricating oil channels formed in the shafts. In working, the lubricating oil enters from the channel 11 and flows to the middle channels 12, 22, 13 and 23 of lubricating oil through the passing-oil grooves 14 and 24 located at a interface between the two shafts 10 and 20, lastly flows to the components to be lubricated through the ring groove of the external circle surface of the connecting shafts to supply oil for the latter. But in working process because of the shafts on the turn state, heights of the middle channels 12 and 22 of lubricating oil of each shaft are different. In a utmost situation as shown in FIG. 1, because the oil outlet of the middle channel 13 of lubricating oil in the first shaft 10 is higher than the one of the middle channel 2 of lubricating oil in the second shaft 20, much lubricating oil can be flown out from the middle channel 23 of lubricating oil in the second shaft 20. Thus it causes the components installed on the first shaft can not be supplied enough lubricating oil, and the lubricating degree of the bearings with low lubricating oil descending, thereby lubrication is not sufficient, and life of the bearings is descending. And it is harmful for operation of a whole apparatus.

### SUMMARY OF THE INVENTION

An object of the present invention is to provide a lubricating oil balance equipment with simple structure, which improves supplying lubricating oil equality.

The object of the present invention is realized by supplying a following lubricating oil balance equipment in a channel of lubricating oil of a shaft:

The lubricating oil equipment includes a main body and an extending portion. The main body is circle-shaped, and there is an inlet in an end of the main body, the extending portion extends outward from one position of the main body along axis direction and is ended at an outlet. Thus the structure makes the lubricating oil entering channel only entered the inlet of the lubricating oil balance equipment and flow out from the outlet of the equipment.

A ring pipe of the present invention is circle-shaped, the section of the ring pipe is circle, squareness or other figures etc. An opening end of the ring pipe extends outward from the position near the whole ring along axis direction.

Because the lubricating oil balance equipment and the structure of which the extending portion extending along axis direction are used, the lubricating oil in the lubricating oil balance equipment can be supplied only when it reaches the extending portion through the highest level of the lubricating oil balance equipment, thus this structure can ensure the uniformity of the lubricating oil in different parts, which is beneficial to lubricate bearings and extend the life of bearings.

### BRIEF DESCRIPTION OF THE DRAWINGS

The above-said advantages and other advantages can be clarified through detailed description of the present invention with the accompany drawing, wherein:

FIG. 1 is showing a situation of lubrication through a channel of lubricating oil in a shaft of the prior art;

FIG. 2 is a front view of the lubricating oil balance equipment of the present invention;

FIG. 3 is a top view of the lubricating oil balance equipment as shown in FIG. 1 of the present invention;

FIG. 4 is a using sketch drawing of the lubricating oil balance equipment as shown in FIG. 1;

FIGS. 5A and 5B are sectional drawings, taken along line A-A and B-B respectively; and

FIG. 6 is a sectional drawing, taken along line V-V.

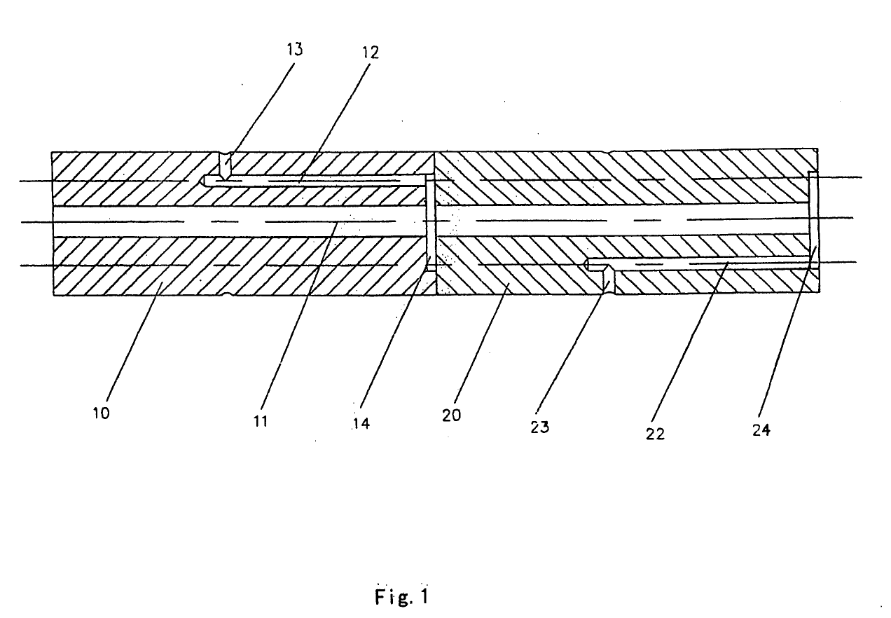

### DETAILED DESCRIPTION OF THE PREFERRED EMBODIMENTS

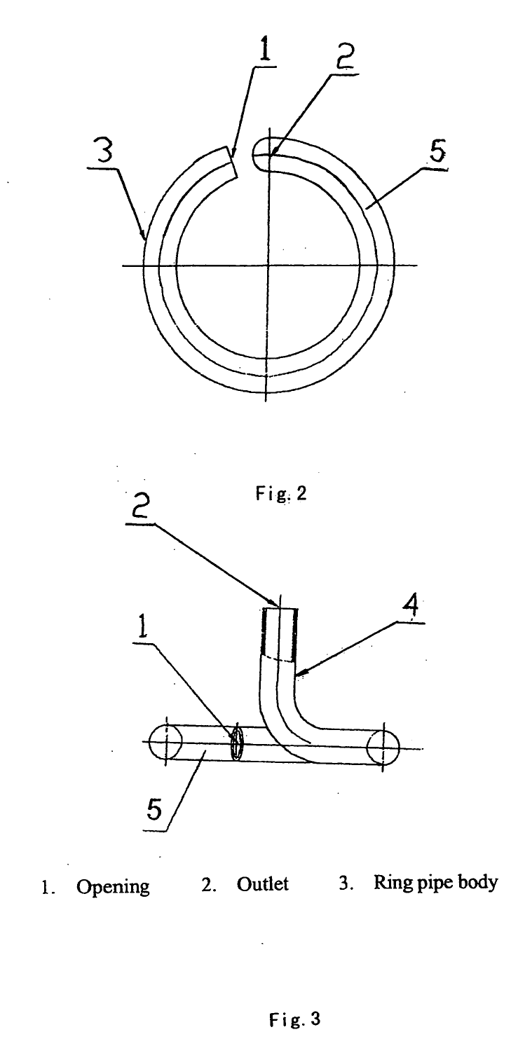

A preferred embodiment of the present invention is detailed described as following consulting FIG. 2 to FIG. 5.

As shown in FIG. 2 and FIG. 3, a lubricating oil balance equipment 3 of the present invention comprises a main body 5 and an extending portion 4, the main body 5 comprises a ring and the extending portion extends outward from one end of the main body along the axis direction. In the FIG. 2 and FIG. 3, reference signs 1 and 2 remark an inlet and an outlet, the extending portion 4 of the ring pipe 3 extends outward along the axis direction and is ended in the outlet. In the preferred embodiment, the ring pipe is circle-shaped. The sectional shape of the ring pipe is circle-shaped or squareness etc. In the preferred embodiment as shown in FIG. 2, the extending portion 4 of the ring pipe extends outward from the position adjacent to the circle along the axis direction.

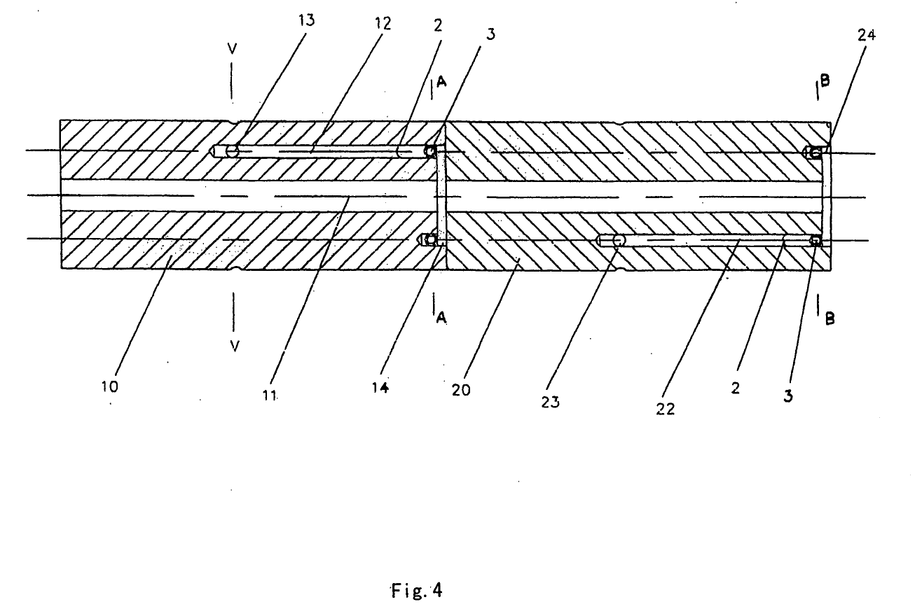

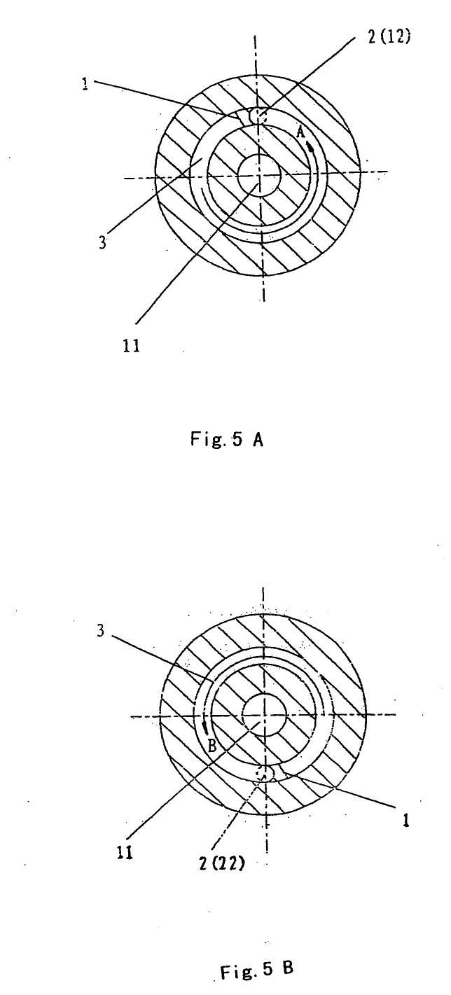

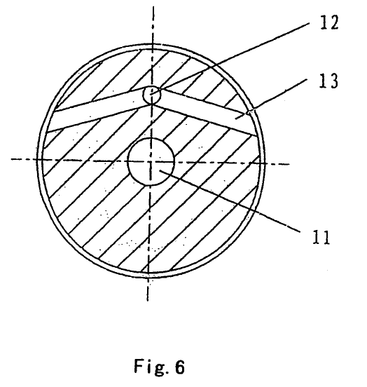

As following working principle of the lubricating oil balance equipment of the present invention is described consulting FIG. 4, FIG. 5A and FIG. 5B: the main body 5 of the lubricating oil balance equipment 3 is set in a ring groove formed in undersides of passing oil concaves 14 and 24. And the extending portion 4 of the lubricating oil balance equipment 3 is inserted in the middle channels 12 and 22 of lubricating oil. The external diameter of the extending portion 4 is the same as the internal diameter of the middle channels 12 and 22 of lubricating oil basically. So that the middle channels 12 and 22 of the lubricating oil are airproofed. Meanwhile the lubricating oil entering the channel 11 can not directly flow into the middle channels 12 and 22 of lubricating oil through the passing oil concaves 14 and 24 as the prior art, but only can enter from the inlet of the lubricating oil balance equipment and flows to the end of the extending portion 4 i.e. the outlet 2 at the effect of pressure, therefore, enters the middle channels 12 and 22. As above-said the lubricating oil flows out to the components to be lubricated from discharge channels 13 and 23. It can be seen from sectional views of FIG. 5A and FIG. 5B, lubrication oil from the channel 11 only can enter from the inlet 1 of the lubrication oil balance equipment 3, then as shown in arrowheads A and B of the FIG. 5A and FIG. 5B, lubrication oil reaches the outlet 2 of the lubrication oil balance equipment 3 passing by the highest point. So the lubricating oil's pressure of each shaft keeps consistent basically to ensure that the lubricating oil's pressure of each point to be lubricated is consistent and even, wherever the turn position of the shaft. So as to each point to be lubricated can get consistent and even lubricating oil basically, furthermore, ensure that whole system can get the appropriate lubricating oil to increase the life of the whole system.

FIG. 6 is a sketch map of a location of a discharge channel 13 of lubrication oil in the shaft. It can be seen from the FIG. 6 when the middle channel 12 of lubricating oil is at the highest point, a location of the discharge channel 13 of lubricating oil is the same as the middle channel 12 of the lubricating oil or lower than the middle channel 12 of lubricating oil. And a horizon position of the outlet 13 of an offset hole is lower than the middle channel 12. So the middle channel 12 of lubrication oil is the highest to ensure that the pressure of each point to be lubricated of every shaft is even and same in any situation

Indeed above description is only exemplary, and the person skilled in this field can conceive that it may achieve the object of the present invention not by the single lubricating oil balance equipment but by the end of the shaft is processed a guiding cavity as the above-said lubricating oil balance equipment.

So, the object of the given description of the present invention is only used to give an example, and does not limit the present invention. Various modifications or changes in many modes and details can be made by those skilled in the art without departing from the spirit and scope of the present invention and covered in the claims of the present invention.

1. A lubricating oil balance equipment installed in a lubricating oil channel of a shaft, characterized in that it includes a ring main body and an extending portion, the extending portion extends outward from the main body along axis direction, there is an inlet in the main body and the extending portion is ended in an outlet, so that lubricating oil from the lubricating oil entrance channel only can enter from the inlet of the main body and flow out from the extending portion through the main body.

2. The lubricating oil balance equipment installed in a lubricating oil channel of a shaft as claimed in claim 1, wherein the lubricating oil balance equipment is a single component.

3. The lubricating oil balance equipment installed in a lubricating oil channel of a shaft as claimed in claim 1, wherein said lubricating oil balance equipment is a guiding cavity processed in an end of the shaft.

4. The lubricating oil balance equipment installed in a lubricating oil channel of a shaft as claimed in claim 1, wherein said main body is ring-shaped.

5. The lubricating oil balance equipment installed in a lubricating oil channel of a shaft as claimed in claim 1, wherein sectional shape of said main body is circle.

6. The lubricating oil balance equipment installed in a lubricating oil channel of a shaft as claimed in claim 1, wherein sectional shape of said main body is of squareness.

7. The lubricating oil balance equipment installed in a lubricating oil channel of a shaft as claimed in claim 1, wherein said extending portion extends outward along axis direction from the position adjacent to the circle.

8. A shaft having the lubricating oil balance equipment of the claim 1, wherein the shaft comprises an entrance channel of lubricating oil, a middle channel of lubricating oil and a discharge channel of lubricating oil; lubricating oil can be supplied to components to be lubricated by entering form the entrance channel of lubricating oil and passing through the middle channel of lubricating oil and the discharge channel of lubricating oil; the inlet of said lubricating oil balance equipment is connected to the entrance channel of lubricating oil, the outlet of said lubricating oil balance equipment is connected to the middle channel of lubricating oil and the entrance channel of lubricating oil and the middle channel of lubricating oil are sealed off each other, so that the lubricating oil can reach the middle channel of lubricating oil only through the lubricating oil balance equipment.

9. The shaft as claimed in claim 8, wherein the height of the discharge channel of lubricating oil is not higher than that of the middle channel of lubricating oil while the middle channel of lubricating oil is in the highest position.

10. The shaft as claimed in claim 8, wherein the external diameter of the extending portion of said lubricating oil balance equipment is same as the internal diameter of the middle channel of lubricating oil so as to airproof the middle channel of lubricating oil.

11. A mill having said lubricating oil balance equipment of the claim 1.

12. A mill having said shaft of the claim 8.
